(19) United States
(12) Patent Application Publication
(10) Pub. No.: US 2026/0022268 A1
(43) Pub. Date: Jan. 22, 2026

(54) POWDER COATING COMPOSITION

(71) Applicant: ALLNEX USA INC., Alpharetta, GA (US)

(72) Inventors: Callistus EZEAGU, Woodstock, GA (US); Daminda Sampath NAVARATHNE, Johns Creek, GA (US); Sarah SULLIVAN, Richmong Hill, GA (US); Roberto CAVALIERI, Padova (IT)

(73) Assignee: ALLNEX USA INC., Alpharetta, GA (US)

(21) Appl. No.: 18/993,153

(22) PCT Filed: Jul. 10, 2023
(86) PCT No.: PCT/US2023/027271

§ 371 Date: Jan. 10, 2025

Related U.S. Application Data
(60) Provisional application No. 63/388,809, filed on Jul. 13, 2022.

(51) Int. Cl. C09D 167/02; B01J 31/02; C09D 5/03; C09D 7/63

(52) U.S. Cl. CPC C09D 167/02; B01J 31/0237; B01J 31/0244; B01J 31/0268; C09D 5/033; C09D 7/63

(57) ABSTRACT

A powder coating composition comprising an acid functional polyester resin A formed by reacting one or more polyol constituents, wherein at least 90 mole % of the polyols constituents is neopentylglycol, with one or more poly acid constituents wherein at least 87 mole % of the poly acid constituents is isophthalic acid (IPA); wherein polyester resin A has an Acid Number (AN) of between 20 and 90 mg KOH/g; and a hydroxyl value of less than 50, preferably less than 15 mg KOH/g; a glycidyl functional acrylic resin B having a weight average molecular weight of between 2500 and 7000; a curing catalyst C capable of catalyzing the reaction between the polyester resin A and the acrylic resin B; and optionally β-hydroxyalkylamide D.

### FIELD OF THE INVENTION

The present invention relates to a powder coating composition, a process for providing a coated substrate having improved edge coverage using the powder coating composition, a method for making a powder coating composition and an article coated with the powder coating composition.

Powder coating is an advanced, fast-growing technology that is widely recognized for its durability, gloss retention, weatherability, ability to apply up to 200 microns high thickness, and unlimited range of colors, finishes, glosses and textures. All this, combined with its ability to prevent corrosion on metallic substrates (considering that corrosion has a very high direct cost) makes powder an important technology in the coatings world.

In addition, powder coatings provide solvent-free finishing and almost 100% recyclable processes for the uncoated powder paint, making them an important part of a sustainable or green building project that incorporates low VOC-emitting products.

Even if the powder coatings are predominantly applied on metal substrates, it is difficult to coat uniformly certain parts, such as corners and edges, through a standard coating application.

The low coating thickness on the edges, may result in a poor corrosion protection and still represents a general problem of the current technology.

Different solutions have been proposed, which includes for example the application of multiple powder coating layers where the first has a low flow providing good edge coverage at the same time with strong orange peel, followed by the application of a second coating with better flow, but limited thickness and coverage on the edges. This requires at least two applications resulting in a reduced productivity and higher risks of inconsistencies.

There remains a need to find a single coating that combines outstanding edge coverage and protection from corrosion and at the same time has a good flow and general applicative performances.

### DESCRIPTION OF THE RELATED ART

Resistance to corrosion in coatings for Agricultural Construction Equipment is a very important characteristic and powder coatings compositions with improved edge coverage have been proposed as a solution to this problem for many years.

For example U.S. Pat. No. 10,940,505 B2 describes powder coatings with improved edge coverage, obtained by applying dry on dry two powder coatings, the first with a short plate flow and a strong orange peel with good edge coverage and the second top coat with longer plate flow but providing poor edge coverage, and curing both the coatings together.

WO 2021/174086 A1 describes powder coatings with improved edge coverage obtained by applying a primer which includes a catalyst, or an active component, or a rheology modifier of the powder coating, followed by applying the top coating.

The application of two layers reduces the productivity of the coating line leading to process inefficiency and delay, and increases the complexity at the end user activity.

At the same time the combination of solid superdurable carboxylated polyester combined with glycidylmethacrylate (GMA) acrylic resin, optionally in presence of additional hardeners such as β-hydroxy-alkylamide, is known, as for example described in JP6567783, where it is reported that a GMA based acrylic resin with specific weight average molecular weight and solubility parameter, combined with a carboxylic acid group containing carboxylated polyester with specific solubility parameter and difference of solubility parameter, is providing a coating showing good general properties including scratch resistance. However, these polyesters have a high amount of OH functional groups present (high OH value) which are not taking part in the reaction with GMA based acrylic resin and β-hydroxy-alkylamide and may lead to reduced chemical resistance due to the limited increase of the molecular weight of the coating obtained during the curing.

Another example is EP0522648 A1, disclosing that GMA based acrylic resin combined with a carboxylated polyester containing at least 15 mole % in the polyacids mixture of 1,4 cyclohexanedicarboxylic acid (CHDA) is providing good solvent and impact resistance. However the polyesters described in the examples have a low Tg, from 39 to 44° C., which is due to the presence of high amount of CHDA. This results in a reduced storage stability of the polyester and also in a reduced storage stability of the powder coatings made thererof. Additionally, the high amount of CHDA is reducing the outdoor durability of coatings when compared with the coatings made of similar polyesters having smaller amounts of CHDA.

### SUMMARY OF THE INVENTION

It is accordingly an object of present invention to provide a powder coating composition that overcomes the above described drawbacks. Further it is an object of present invention to provide a powder coating composition, which upon single application and after being thermally cured, results in a coating, exhibiting a good edge coverage and a corner coverage. In addition, it is an object of the invention that the composition provides a film that after curing has a combination of other physical properties such as good smoothness, flexibility (cupping), outdoor durability, chemical and corrosion resistance.

These objects are met, at least partially, by a powder coating composition according to claim 1.

Accordingly, a first aspect of the invention is related to a powder coating composition comprising:
an acid functional polyester resin A formed from reacting one or more polyol constituents, wherein at least 90 mole % of the polyols constituents is neopentylglycol, with one or more poly acid constituents wherein at least 87 mole % of the poly acid constituents is isophthalic acid (IPA); wherein polyester resin A has an Acid Number (AN) of between 20 and 90 mg KOH/g; and a hydroxyl value of less than 50, preferably less than 15 mg KOH/g;
a glycidyl functional acrylic resin B having a weight average molecular weight of between 2500 and 7000;
a curing catalyst C capable of catalyzing the reaction between the polyester resin A and the acrylic resin B;
optionally a β-hydroxyalkylamide D.

It was surprisingly found that such powder coating composition may exhibit, upon curing, an excellent combination of physical properties such as smoothness, flexibility, chemical and corrosion resistance and, above all, an outstanding edge coverage when tested according to the Low Voltage Wet Sponge test method (ASTM D5162) and/or an outstanding corner coverage when tested via the Standard Method for Corner Coverage of Powder Coatings (ASTM Method D2967-7), even after coating with only one single layer.

In a second aspect, the invention is related to a process for providing good edge coverage of a metal substrate comprising the steps of.
contacting an uncoated metal substrate having a surface and an edge with a single layer of a powder coating composition according to the first aspect;
curing the powder coating composition,
   wherein the powder coating composition provides an edge coverage rating of at least 2.0 when tested via the Low Voltage Wet Sponge Test Method (ASTM D5162).

In a third aspect, the invention is related to a method for making a powder coating composition according to the first aspect, comprising the steps of
preparing acrylic resin B in a reactor;
mixing acrylic resin B with catalyst C before or while leaving the reactor to form a BC mixture; or
mixing acrylic resin B with catalyst C through extrusion to form a BC mixture; or
mixing acrylic resin B with catalyst C through dry blending to form a BC mixture;
dry blending the BC mixture, the polyester resin A and optionally β-hydroxyalkylamide D to form a blend;
extruding the blend to form a homogenized mixture;
cooling and grinding the homogenized mixture.

In a fourth aspect, the invention is related to an article, preferably having a metal substrate coated, either partially or entirely, with a powder coating composition according to the first aspect or a powder coating composition made by the method according to the third aspect.

Upon application of one layer and curing, the coating compositions of the invention permit to obtain smooth, high gloss finishes, providing good solvent resistance, flexibility, corrosion resistance and edge coverage.

In a fifth aspect, the invention is related to a metal substrate made by a process according to the second aspect of the invention.

In a sixt aspect, the invention is related to the use of the powder coating composition according to the first aspect, or made by the method of the third aspect, for providing a good edge coverage of a metal substrate by a single layer, whereby the powder coating composition provides an edge coverage of at least 2.0 when tested via the Low Voltage Wet Sponge test method (ASTM D5162).

### FIGURE DESCRIPTION AND DEFINITIONS

FIG. 1 represents a metal test plate used for the ASTM D5162 test whereby the plate has a pinhole (1), a substrate 2, four sides: top (2), two sides (3) and bottom (4), edges (5) and four corners (6).

FIG. 2 represents a metal test bar used for the ASTM Method D2967-7 test, whereby the bar has corners (7)—only four are indicated; and flat surfaces (8)—only two are indicated.

A “resin” is meant to designate a polymer having functional groups which is able to cure or crosslink via reactions involving its functional groups, said reactions being induced by means of heat (thermoset compositions) and/or radiation (for radiation curable compositions), connecting the polymer chains together through the formation of permanent covalent (crosslink) bonds, resulting in a cured resin.

By “functional group” is meant herein a covalently bonded group of atoms within a molecule, such as for example a carboxylic acid group (—COOH), a hydroxyl group (—OH) or an oxirane (also called glycidyl) group, which is capable of reacting with a functional group of another molecule. For example a carboxylic acid functional polyester resin contains carboxylic acid functional groups that are capable of reacting with the functional groups of another molecule, for example a glycidyl epoxy acrylic resin containing glycidyl groups.

The terms “amorphous” and “crystalline” (sometimes including “semi-crystalline”) used to characterize a resin or a thermosetting powder coating composition, are informal terms used in the art to indicate the predominant character of the relevant resin or thermosetting powder coating composition, in respect to its degree of crystallinity. An amorphous resin does not have a melting temperature (Tm) as it melts over a range of temperature whereas a crystalline resin typically has a Tm. An amorphous resin is typically defined by its Tg. In case in which a crystalline resin has a Tg, then its Tg is lower than its Tm. By “Tg” is meant herein the glass transition temperature. The Tg is measured using Differential Scanning Calorimetry (DSC) as described herein.

The curing of the thermosetting powder coating composition of the invention takes place using heat and can be called “heat curing” for example using infrared (IR) lamps. For clarity, the term heat curing does not include radiation curing such as ultraviolet (UV) or electron beam induced curing.

A curable thermosetting powder coating composition is applied on an object, for example an article, and forms, after heat curing, a film or coating on the subtrate. Such coating can be called a paint typically when the composition contains pigment(s).

A composition containing functional resins and, when present, curing catalyst, these functional resins being able to react together to form upon cure (i.e. upon crosslinking) the cured composition, is often called the binder component of a coating composition. Other components like pigments, flow additives etc can be added to the binder to form the final composition applied on the object to form after curing a coating on the object.

“Edge coverage” according to this invention means that the edges of a metal substrate, are covered by applying and curing one layer of powder coating composition that provides an edge coverage of at least 2.0 when the composition is tested according to the Low Voltage Wet Sponge Test Method (ASTM D5162).

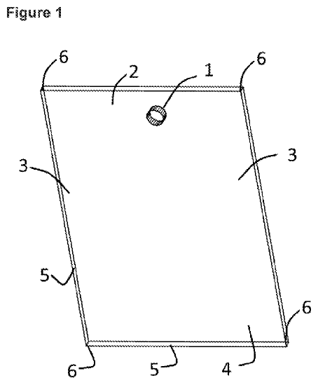

The “Low Voltage Wet Sponge Test Method” according to the invention is the test as described in ASTM D5162 whereby a single layer of powder coating is provided on a metallic test panel. The test panel has four corners (6) and has edges (5) on the four sides of the panel: top (2), bottom (4), and two sides (3) (see FIG. 1). The edges are about 0.5 mm thick. The metal test panel has a hole (1) for hanging and holding the panel. The panel is hanging on a holder via a metallic wire perpendicular to the floor of the hood, which is a standard procedure. After curing, the thickness of the powder coating is on average 50-125 μm. A pinhole detector such as DeFelsko PosiTest LPD Pinhole Detector, is used to detect discontinuities and pinholes on the edges (5) and corners (6) according to ASTM D5162 modified by using tap water instead of tap water and low sudsing wetting agent.

Rating the level of substrate exposure (i.e. discontinuities and pinholes) at the edges and corners is as follows (the numbers in brackets refer to the numbers in FIG. 1):
0.0 No coverage on the edges (5) along the bottom (4), sides (3) and no coverage on the corners (6) (bad edge coverage)
1.0 Some coverage on the edges (5) along the bottom (4) or sides (3) but no coverage on the edge along the top (2) and the corners (6) (poor edge coverage)
2.0 Complete coverage on the edge (5) along the bottom (4), and some coverage on the edges (5) along the sides (3) but no coverage on the corners (6) (good edge coverage)
3.0 Full coverage on the edges (5) along the four sides (2, 3, and 4), including all the corners (very good edge coverage).

It is possible to rate intermediate values (1.5, 2.5) when the result is better than the lower level but still not fulfilling the requirement of the following level.

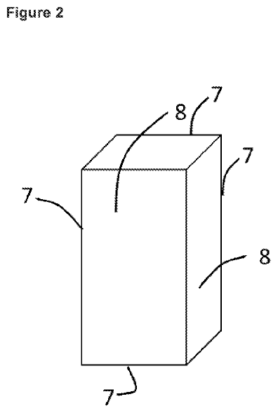

As used herein, the term “corner coverage” refers to the ratio of the average corner thickness of the coating of the test bar to the average face thickness of the coating of the test bar, as described in ASTM Method D2967-7 (2013) (Standard Test Method for Corner Coverage of Powder Coatings), modified by spraying the substrate (a square test bar) with the powder coating composition instead of dipping the substrate in a fluidized bed. “Corner coverage” is the ratio of the average corner thickness of the coating of the test bar to the average face thickness of the coating of the test bar, expressed as a percentage, where the face coverage refers to the thickness of the coating applied to each of the flat surfaces ((8) in FIG. 2) of the test bar and the corner thickness refers to the average thickness of the coating on sharp 90° corners of steel bars ((7) in FIG. 2). It is herewith noted that the term “corner” as used in “edge coverage” (FIG. 1 (6)) has a different meaning then when the term is used in “corner coverage” (sharp 90° corners of bars (FIG. 2 (7))

### DETAILED DESCRIPTION OF THE INVENTION

### Acid Functional Polyester Resin A

The polyester resin A is acid functional which means that the polyester comprises terminal carboxylic acid groups. The acid functional polyester resin A is formed from one or more polyol constituents, wherein at least 90 mole % of the polyols constituents is neopentylglycol, and one or more poly acid constituents wherein at least 87 mole % of the poly acid constituents is isophthalic acid (IPA); wherein polyester resin A has an Acid Number (AN) of between 20 and 90 mg KOH/g; and a hydroxyl value of less than 50, preferably less than 15 mg KOH/g;

The polyester resin A can also be called a “superdurable polyester”, which is meant to designate herein a polyester containing at least 87 mole % of isophthalic acid on the polyacid moles parts and at least 90 mole % of neopentylglycol on the polyols moles part.

The carboxylic acid group containing polyester A of the present invention is a polyester resin which is a carboxylic acid functional polyester. It is typically obtainable a) or by reacting a polyol with a diacid and/or its anhydride to form a hydroxyl functional polyester, which is then reacted with a polycarboxylic acid and/or its anhydride or b) by reacting in a single step all the polyols with all the di-and poly-carboxylic acids and/or their anhydrides.

The carboxylic acid functional polyester resins A according to the present invention are preferably prepared reacting all the polyols with all the di- and poly-carboxylic acids and/or their anhydrides in a single step.

The carboxylic acid group containing polyester resin A of the invention in general has an Acid Number of at least 20, preferably at least 30, more preferably at least 40 mg KOH/g. The Acid Number of the polyester resin A in general is at most 90, preferably at most 75, more preferably at most 60 mg KOH/g.

The polyester resin A has a hydroxyl value of less than 50 preferably less than 15, even more preferably less than 10 mg KOH/g. It was surprisingly found that when the the polyester resin A has a sufficiently low viscosity and such a low amount of residual OH functional groups, it allows to obtain similar or better applicative performances and better flow compared to the polyesters having a higher hydroxyl value and viscosity, which results in a lower flow and poor appearance so that an additional coating layer would be required to obtain good appearance. On the other hand, the coating compositions according to the invention only require one layer of coating to have both a good edge coverage and a good appearance.

The diacid constituents of polyester A in general are composed of from 87 to 100 mole percent of isophthalic acid, and of from 0 to 13 mole percent of another diacid constituent selected from one or more aliphatic, cycloaliphatic and/or aromatic diacids, such as: terephthalic acid, fumaric acid, maleic acid, phthalic anhydride, CHDA, 1,3-cyclohexanedicarboxylic acid, 1,2-cyclohexanedicarboxylic acid, succinic acid, adipic acid, glutaric acid, pimelic acid, suberic acid, azelaic acid, sebacic acid, 1,12-dodecanedioic acid, undodecanedioic acid, tridecanedioic acid, tetradecanedioic acid, hexadecanedioic acid, eptadecanedioic acid, octadecanedioic acid, or the corresponding anhydrides and any mixture thereof. CHDA and adipic acid are the most preferred.

By polybasic organic carboxylic acid is meant to designate organic compounds comprising at least 3 carboxylic acid groups. The polybasic organic acid can be used in acid form, in anhydride form or as a mixture of acids and anhydrides. The polybasic organic acids of polyester A in general are present as from 0 to 10 mole percent of the total acids and/or anhydrides of the polyester A. The polybasic organic acids are preferably selected from trimellitic acid, pyromellitic acid, trimellitic anhydride and pyromellitic anhydride and any mixture thereof. Trimellitic anhydride is most preferred.

The polyol constituent of polyester resin A is composed of at least 90 mole % neopentyl glycol. The polyol constitutent in polyester resin A can contain further polyols having 2 OH groups, for example a glycol, or at least 3 OH groups, such as for example trimethylolpropane.

Such glycol can be from 0 to 10 mole percent of another glycol constituent selected from one or more aliphatic and/or cycloaliphatic glycols, such as: ethylene glycol, diethylene glycol, 1,3 propanediol, propylene glycol, 1,4-butanediol, 1,6-hexanediol, 1,4-cyclohexanediol, 1,4-cyclohexanedimethanol, 2-methyl-1,3-propanediol, 2-butyl-2-ethyl-1,3-propanediol, hydrogenated Bisphenol A, hydroxypivalate of neopentyl glycol. 1,6-hexanediol, is the most preferred.

The polyols constituent of polyester resin A with at least 3 OH groups in general are present as from 0 to 10 mole percent of the total hydroxyl groups of the polyester resin A. The polyols constituent of polyester A with at least 3 OH groups are preferably selected from glycerine, trimethylolpropane, tris-hydroxyethylisocyanurate (THEIC), ditrimethylolpropane, pentaerythritol. Trimethylolpropane is most preferred.

Advantageously the carboxyl acid functionality of the polyester resin A is higher than 1.2, preferably 1.4 and more preferably 1.6.

Advantageously the carboxyl acid functionality of the polyester A is lower than 2.6, preferably 2.4 and more preferably 2.2 (functionality defined as the average number of acid groups per molecule as by “measured Mn”/(56100/ANV) wherein ANV is the acid number value).

The carboxyl functional polyester resin A of the present invention advantageously has a number average molecular weight (Mn) as determined by gel permeation chromatography (GPC) of at least 1000, preferably at least 1500. The Mn of this polyester resin A preferably is at most 3000, more in particular is at most 2500, as determined by GPC (using polystyrene standards and tetrahydrofuran as eluent, at 35° C.).

The carboxyl functional polyester resin A of the present invention advantageously has a weight average molecular weight (Mw) as determined by gel permeation chromatography (GPC) of at least 2500, preferably at least 4000. The Mw of this polyester resin A preferably is at most 11000, more in particular is at most 8000, as determined by GPC (using polystyrene standards and tetrahydrofuran as eluent, at 35° C.).

Advantageously the carboxyl functional polyester resin A of the present invention is an amorphous polyester.

The carboxyl functional polyester resin A of the invention advantageously has a glass transition temperature, measured by Differential Scanning Calorimetry (DSC) according to ASTM D3418 with a heating gradient of 10° C. per minute, of from 45 to 90° C. Preferably this polyester resin A has a glass transition temperature below 70° C., more preferably below 63° C.

The carboxyl functional polyester resin A of the invention advantageously has a Brookfield cone and plate viscosity according to ASTM D4287-88, measured at 200° C., ranging from 500 to 10000 mPa·s and preferably between 1200 and 2400 mPa·s.

The polyester resins A according to the present invention may be prepared using conventional esterification techniques well known in the art.

The polyesters are preferably prepared according to a procedure consisting of one or more reaction steps. For the preparation of these polyesters, a conventional reactor equipped with a stirrer, an inert gas (nitrogen) inlet, a thermocouple, a distillation column connected to a water-cooled condenser, a water separator and a vacuum connection tube are used. The esterification conditions used to prepare the polyesters are conventional, namely a standard esterification catalyst, such as dibutyltin oxide, dibutyltin dilaurate, n-butyltin trioctoate, monobutyltin oxide, tin oxalate, sulfuric acid or a sulphonic acid, can be used in an amount from 0.0 to 0.50% by weight of the reactants and optionally, color stabilizers, for example, phosphonite- and phosphite-type stabilizers such as tributylphosphite, triphenylphosphite, can be added in an amount from 0 to 1% by weight of the reactants. Polyesterification is generally carried out at a temperature which is gradually increased from 130° C. to about 190 to 250° C., first at atmospheric pressure or under pressure, then, when necessary, under reduced pressure at the end of each process step, while maintaining these operating conditions until a polyester with the desired hydroxyl and/or acid number is obtained. The degree of esterification is monitored by determining the amount of water formed in the course of the reaction and the properties of the obtained polyester, for example, hydroxyl number, acid number, and viscosity. Final additives including catalysts, can be added in the reactor, while discharging it and/or in the powder coating preparation, during extrusion or mixing.

### Glycidyl functional Acrylic Resin B

The glycidyl functional acrylic resin B of powder compositions according to the invention has a weight average molecular weight of from 2500 to 7000 as determined by GPC (using polystyrene standards and tetrahydrofuran as eluent, at 35° C.). Preferably, the glycidyl functional acrylic resin B has a weight average molecular weight (Mw) as determined by gel permeation chromatography (GPC) of at least 2500, preferably at least 4200. Preferably, the Mw of this glycidyl functional acrylic resin B is at most 7000, more in particular is at most 5500, as determined by GPC (using polystyrene standards and tetrahydrofuran as eluent, at 35° C.).

The glycidyl functional acrylic resin B is preferably obtained from the reaction of glycidyl methacrylate and/or glycidyl acrylate, at least one (meth) acrylic monomer, and optionally an ethylenically monounsaturated monomer different from the glycidyl (meth) acrylate and the (meth) acrylic monomer. The (meth) acrylic monomer is selected from the group consisting of alkyl esters of an α, β-ethylenically unsaturated carboxylic acid having the formula

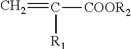

Wherein R₁ is a hydrogen atom or a methyl radical, and R₂ represents an alkyl radical containing from 1 to 18 carbon atoms, and preferably 1 to 6 carbon atoms. Examples of (meth)acrylic monomers include alkyl esters of acrylic acid or methacrylic acid such as ethyl acrylate, butyl acrylate, isobutyl acrylate, 2-ethylhexyl acrylate, and lauryl acrylate, methyl methacrylate, ethyl methacrylate, butyl methacrylate, isobutyl methacrylate and lauryl methacrylate.

The ethylenically mono-unsaturated monomer which can optionally be used is preferably selected from styrene, vinyltoluene, dimethylstyrene, a-methylstyrene, hydroxyethyl acrylate or methacrylate hydroxypropyl acrylate or methacrylate, acrylonitrile, acrylamide, vinyl acetate, etc. alone or as a mixture. The glycidyl group-containing acrylic copolymers B are preferably obtained from about 27 to 47% by weight of glycidyl methacrylate and/or glycidyl acrylate (preferably Glycidylmethacrylate), about 73 to 53% by weight of the (meth)acrylic monomer (preferably methyl-and n-butyl-methacrylate) and about 0 to 20% by weight of the other ethylenically monounsaturated monomer (preferably styrene), in view of the total reaction mixture for making the glycidyl group-containing acrylic copolymers B. These acrylic copolymers are prepared by known polymerization methods, such as polymerization in bulk, in emulsion, or in solution in an organic solvent. The monomers are copolymerized in the presence of a free-radical initiator such as benzoyl peroxide, tert-butyl peroxide, decanoyl peroxide, azo-bisisobutyronitrile, and the like, in an amount of from 0.1 to 7.0% by weight of the monomers.

The preferred glycidyl functional acrylic resin B of the present invention advantageously has a number average molecular weight (Mn) as determined by gel permeation chromatography (GPC) of at least 1000, preferably at least 1500. The Mn of this glycidyl group-containing acrylic copolymer B preferably is at most 2500, more in particular is at most 2000 as determined by GPC (using polystyrene standards and tetrahydrofuran as eluent, at 35° C.).

To achieve a good control of the molecular weight and its distribution, a chain transfer agent can be added during polymerization, preferably one of the mercaptan type, such as n-dodecylmercaptan, t-dodecanethiol, isooctylmercaptan, and the like, halides such as carbon tetrabromide, disulfides or thioethers. The chain transfer agent is used in an amount of from 0 to 10% by weight of the monomers used in the copolymerization.

The glycidyl functional acrylic resin B of the invention in general has an epoxy equivalent weight (EEW) of at least 280, preferably at least 320, more preferably at least 360 g/epoxy equivalent. The epoxy equivalent weight (EEW) of the glycidyl group-containing acrylic copolymer B in general is at most 500, preferably at most 450, more preferably at most 400 g/epoxy equivalent.

The glycidyl functional acrylic resin B of the invention advantageously has a glass transition temperature, measured by Differential Scanning Calorimetry (DSC) according to ASTM D3418 with a heating gradient of 10° C. per minute, of from 35 to 60° C. Preferably this glycidyl group-containing acrylic copolymer B has a glass transition temperature above 40° C., more preferably above 42° C.

The glycidyl functional acrylic resin B of the invention advantageously has a Brookfield cone and plate viscosity according to ASTM D4287-88, measured at 150° C., ranging from 10.000 to 75.000 mPa·s and preferably between 15.000 and 55.000 mPa·s.

An example of commercially available glycidyl functional acrylic resin B is Almatex PD 3402, from Anderson Development Company but more are available from DIC, Estron, and Allnex between others.

Advantageously the functionality of the glycidyl functional acrylic resin B is at least 2.5 preferably at least 4 and at most 8.5 preferably at most 7.0, (functionality defined as the average number of glycidyl groups per molecule as by “measured Mn”/EEW).

### Catalyst C

The curing catalyst C is capable of catalyzing the reaction between the polyester resin A and the acrylic resin B. Curing catalyst C is typically a thermosetting curing catalyst and can be selected from the group consisting of amines, imidazoles, phosphines, ammonium salts, phosphonium salts, blocked amine or phosphine catalysts, encapsulated catalysts and combinations thereof, preferably combination of arylphosphoniumhalogenide with imidazoles and tertiary amines, more preferably ethyl-triphenylphosphonium bromide (BETP) with 2-methyl-imidazole and tributylamine.

The total wt % of curing catalyst C in the powder coating composition is between 0.2 and 1.3 wt % in view of the total amount of weight of the powder coating composition.

Advantageously the total % of the curing catalyst C is at least 0.2% preferably at least 0.3% and at most 1.3% preferably at most 1.2%.

When a combination of catalysts is used, the ratio between the 3 catalysts can be between 0/0/100 to 0/100/0 and 100/0/0.

The catalyst C can be mixed with the polyester resin A or glycidyl functional acrylic resin B before or while leaving the reactor of the synthesis or in a preliminary mixing or extrusion, but preferably with the glycidyl group-containing acrylic copolymer B.

### Optional β-Hydroxyalkylamide D

Optionally β-hydroxyalkylamide is added in the powder coating composition. The β-hydroxyalkylamide comprises at least one, preferably two bis-(β-hydroxyalkyl) amide groups. More preferred β-hydroxyalkylamides are those available commercially from EMS under the trade designations Primid XL552, Primid QM1260 and Primid SF 4510 and also those described in U.S. Pat. Nos. 4,727,111, 4,788,255, and 54,076,917, EP 0322834 and EP 0473380

For Primid XL 552, typical hydroxylamide number range is 600-725 mg KOH/g and the equivalent weight range is 94-77 g/hydroxylamide group.

Advantageously the ratio between the equivalents of glycidyl functional acrylic resin B (number of moles of glycidyl groups in resin B) combined with, if present, the number of moles of hydroxylamide group of β-hydroxyalkylamide, and the equivalents of carboxylic acid group of polyester resin A (number of moles of carboxylic groups in resin A) is between 33/67 and 67/33, preferably between 45/55 to 55/45.

The ratio between the equivalents of acrylic resin B glycidyl groups-containing acrylic copolymer B (number of moles of glycidyl groups in acrylic resin B) and, the optional if present, number of moles of hydroxylamide groups of β-hydroxyalkylamide D (number of moles of hydroxyalkylamide groups in β-hydroxyalkylamide D) is comprised between 100/01 and 40/60, preferably between 75/25 and 50/50. The powder coation composition may comprise additional components.

In addition to the components described above, compositions within the scope of the present invention can also include one or more components such as carboxyl containing semi-crystaline polyesters as additives typically less than 5% of the powder coating composition. The carboxyl-containing crystalline or semicrystalline polyester resins are those that are based on polycarboxylic acids and polyols. The polycaboxylic acids are e.g. linear, aliphatic dicarboxylic acids having 2 to 22 methylene groups and/or terephthalic acid/isophthalic acid in amounts of at least 85 mol %, based on the total amount of all polycarboxylic acids used. As polyols can be used. e.g. inter alia (cyclo)aliphatic alcohols having 2 to 10 C atoms.

Other components includes flow control agents, for example ADDITOL®P 896, ADDITOL®P 824, MODAFLOW®P 6000 (ALLNEX), RESIFLOW®P-67 and PV5 (ESTRON), ACRONAL®4F, ACRONAL®LR8820 (BASF), BYK360 and BYK®361 (BYK Chemie) degassing agents such as Benzoin (BASF), fillers, UV-light absorbers such as TINUVIN@900 (BASF), hindered amine light stabilizers such as TINUVIN@144 (BASF), other stabilizing agents such as TINUVIN®312 and 1130 (BASF), antioxidants such as IRGANOX®1010 (BASF) and stabilizers of the phosphonite or phosphite types like IRGAFOS®168 (BASF), ULTRANOX®626 (SI GROUP), DOVERPHOS®613 (DOVER) or HOSTANOX®P-EPQ (CLARIANT), pigments, fillers and dyes.

Both pigmented and clear lacquers can be prepared. A variety of dyes, fillers and pigments can be utilized in the composition of this invention. Examples of useful pigments, fillers and dyes are: metallic oxides such as titanium dioxide, iron oxide, zinc oxide and the like, metal hydroxides, metal powders, sulphides, sulphates, carbonates, silicates such as ammonium silicate, carbon black, talc, china clay, barytes, iron blues, lead blues, organic reds, organic maroons and the like.

The powder composition usually contains less than 40% by weight of these additional components on the total powder coating.

Preferably, the powder coating composition has a gel time measured at 200° C. of below 100 seconds, preferably between 20 and 50 seconds.

The components of the composition according to the invention may be mixed by dry blending in a mixer or blender (e.g. drum mixer). The premix is then generally homogenized at temperatures ranging from 50 to 120° C. in a single screw extruder such as the BUSS-Ko-Kneter or a twin screw extruder such as the PRISM or Werner & Pfleiderer ZSK. The extrudate, when cooled down, is generally ground to a powder with a particle size ranging from 10 to 150 μm. The powdered composition may be deposited on the substrate by use of a powder gun such as an electrostatic CORONA gun or a friction charging TRIBO spray gun. On the other hand, well known methods of powder deposition such as the fluidized bed technique can also be used. After deposition the powder is usually heated with different heating methods including IR, to a object temperature between 140 and 220° C., preferably at about 180° C. to 200° C. for 10 to 30′ causing the particles to flow and fuse together to form a smooth, uniform, continuous, non-cratered coating on the substrate surface.

In one embodiment, the powder coating composition provides good edge coverage rating (2.0) or very good edge coverage rating (3.0) or any level in between these ratings.

In yet another embodiment the powder coating composition provides a corner coverage above 10%, preferably above 15%, more preferably above 20%.

The powder compositions according to the invention may provide an outstanding flow and permit to obtain glossy coatings, excellent edge coverage with a single coating, mechanical properties and solvent resistance.

The invention is further related to a process for providing a good edge coverage of a metal substrate comprising the steps of:
contacting an uncoated metal substrate having a surface and an edge with a single layer of a powder coating composition as described above;
curing the powder coating composition;
   wherein the powder coating composition provides an edge coverage rating of at least 2.0 when tested using Low Voltage Wet Sponge Test Method (ASTM D5162).

Preferably, the curing occurs at a temperature ranging from 160 to 210° C., more preferably from 180° C. to 200° C., during 10 to 30 minutes preferably 10 to 15 minutes.

In one embodiment wherein the single layer after curing has a thickness of from 50 to 125 μm.

The invention is also related to a metal substrate coated by such process.

The invention is also related to a method for making a powder coating composition comprising the steps of
preparing acrylic resin B in a reactor;
mixing acrylic resin B with catalyst C before or while leaving the reactor to form a BC mixture; or
mixing acrylic resin B with catalyst C through extrusion to form a BC mixture or;
mixing acrylic resin B with catalyst C trough dry-blending to form a BC mixture;
dry blending the BC mixture, the polyester resin A and optionally β-hydroxyalkylamide D to form a blend;
extruding the blend to form a homogenized mixture;
cooling and grinding the homogenized mixture.

The invention is further related to an article, which has typically a metal substrate, coated, either partially or entirely, with a powder coating composition as described above or with a powder coating composition made by the method as described above.

The invention is further related to the use of a powder coating composition as described above, or made by the method as described above for providing a good edge coverage of a metal substrate by applying single layer, whereby the powder coating composition provides an edge coverage of at least 2.0 when tested via the Low Voltage Wet Sponge test method (ASTM D5162).

### METHODS

### 1. Acid Number AN

A quantity of resin is accurately weighed out into a 250 ml conical flask. 50-60 ml of tetrahydrofuran is then added. The solution is heated gently until the resin is entirely dissolved and ensuring the solution does not boil. The solution is cooled to room temperature, then 3 drops of phenolphthalein are added before to be titrated with standard potassium hydroxide until the end point is reached. The Acid Number is calculated as follows:

$$Acid Number ( mgKOH / g ) = mL \times N * 56 , 1 / g$$

g=Mass of Resin
N=normality of potassium hydroxide solution

### 2. Viscosity

Viscosity is measured following ASTM D 4287 using viscometer Brookfield CAP 2000 (Variable Speed) for viscosity determination of high viscosity polyesters. The required temperature and speed are selected. A small amount of the resin sample is placed on the heated plate such that when the cone is lowered, a small excess spreads out around the side. Start the rotation of the spindle. The sample is thoroughly de-gassed by raising and lowering the cone several times, while stopping the cone rotation button. Once fully degassed, a reading is then taken. This process is repeated until a reproducible highly stable reading is obtained.

### 3. Tg by DSC

The Tg values reported herein are the mid point Tg's determined at the inclination point of the DSC curve. The DSC curve was determined using a heating rate of 10° C./min.

### 4. Molecular Weight by GPC

The weight and number average molecular weight and the molecular mass distribution of the polymers was determined with Gel Permeation Chromatography (GPC) on HPLC Perkin-Elmer with Refractive index (RI) detector using as eluent Tetrahydrofuran HPLC grade at 35° C. and three PLgel columns 100-1000-10000 A (300×7.8 mm) 5 microns, Polymer Standards Services (PSS) using Polystyrene standards (Mw range 162 to 96000 Daltons) and Toluene added on every samples as flow marker peak.

### 5. Functionality

Functionality defined as the average number of acid or glycidyl groups per molecule as calculated by Mn/(56100/AN) or Mn/EEW.

### 6. Epoxy Equivalent Weight (EEW)

The epoxy equivalent weight is the weight of an epoxy compound containing exactly one mole of glycidyl groups, expressed in g/mol.

A quantity of resin equivalent to 0.7-0.8 milliepoxide equivalent accurately weighed out into a 250 ml conical flask. 20 ml of methylene chloride are then added. The solution is heated gently until the resin is entirely dissolved and ensuring the solution does not boil. The solution is cooled to room temperature. Then, with a cylinder, about 0.5-1 g of tetraethylammoniumbromide powder and 4-6 drops of crystal violet indicator are added (colour changes from blue to green).

Then it's titrated immediately by magnetic stirring with the 0.1 N perchloric acid solution until the end point is reached.

### Calculation

$$Epoxide equivalent weight = ( P * 1000 ) / ( ( V - Vo ) * N ) g / epoxy equivalent$$

### Where:

V=ml of 0.1N perchloric acid solution used to titrate the sample
Vₒ=ml of 0.1N perchloric acid solution used to titrate the blank solution
N=normality of perchloric acid
P=sample weight expressed in grams

### 7. Hydroxyl Number OHV

Hydroxyl Number (OHV) is defined as the number of mg KOH equivalent to the amount of acetic acid esterified after the acetylation reaction of the hydroxyl group of a 1 g sample (reference method DIN 53240)

Acetylating mixture: 15 g of acetic anhydride are diluted with Analytical grade pyridine in a 250 ml Erlenmeyer flask.

The determination must be carried out twice and, at the same time, a blank test must be completed following the procedure reported here below.

20 ml of acetylating mixture are added to the sample accurately weighed based on the expected hydroxyl value in a flask. An air cooler is inserted and the flask is put in the thermostatic bath at 100° C. and left to reflux for 1 hour. Then 30 ml of tetrahydrofuran are added to wash thoroughly the air cooler followed from the addition of 10 ml of distilled water. After vigorous shaking the solution is let in the bath again for 10 minutes more. After removing the flask from the bath 30 ml more of tetrahydrofuran are added. After shaking again the flask, the solution is let to cool down.

Indicator solution: 0.80 g of Thymol Blue and 0.25 g of Cresol Red are dissolved in 1 L of methanol.

The OHV is determined by manual titration of the prepared cold blanks and sample flasks with standardized 0.5 N methanolic potassium hydroxide solution by using 10 drops of indicator solution. The end point is reached when the colour changes from yellow to grey to blue and gives a blue colouration which is maintained for 10 seconds. The hydroxyl number is then calculated according to:

$$Hydroxyl Number = ( B - S ) \times N \times 56.1 / M + AN$$

### Where:

B=ml of KOH used for blank titration
S=ml of KOH used for sample titration
N=normality of potassium hydroxide solution
M=sample weight (base resin)
AN=acid number of the sample in mg KOH/g

### 8. Gel Time Measurement

The time needed by the test sample to change its physical state from liquid (molten) to solid-gummy (gelled), is measured: this time is called “gel-time”. Both finished coatings or physical blends of resins and suitable hardeners can be tested (DIN 55990 part 8, ISO 8130-6).

The tester plate is preheated to the test temperature. A spoonful of test sample of powder paint corresponding to about 0.9 g, is introduced into one of the niches (cavity) of the tester plate. Stop-watch is started and, immediately after, test sample is stirred by means of a metal pencil, mildly and continuously with circular motion until melt viscosity begins to increase appreciably. By vertically raising the metal pencil, it is realised that the material is gelified once the strand breaks readily: at this time the stop-watch is stopped.

The total time to end the test (when gelification occurs), in seconds at the specified test temperature represents the result of the measurement.

### EXAMPLES

### Example 1 Polyester A

425 parts of neopentyl glycol were placed in a conventional four neck round bottom flask equipped with a stirrer, a distillation column connected to a water cooled condenser, an inlet for nitrogen and a thermometer attached to a thermoregulator. The flask contents were heated, while stirring under nitrogen, to a temperature of approximately 140° C. at which point 721 parts of isophthalic acid and 1 part of monobutyltinoxide were added. The reaction was continued at 240° C. under atmospheric pressure until about 95% of the theoretical amount of water was distilled and a transparent carboxyl functionalized prepolymer was obtained. To the first step polyester at 200° C., 0.6 parts of triphenylphosphite were added and at a temperature of 235° C. vacuum of 50 mm Hg was gradually applied. Once the target Acid Number and viscosity were achieved, the polyester was cooled at 200° C. and 0.3 parts of BETP were added. After 60′ following characteristics were obtained:
Acid Number: 35 mg KOH/g
Brfld (Cone/Plate): 2000 mPa·s at 200° C.
Tg (DSC): 61° C.
Hydroxyl Number OHV: 4.5 mg KOH/g
Molecular weight distribution of: Mn 2363/Mw 6245 Functionality: 1.5

### Example 2 Glycidyl Group-Containing Acrylic Copolymer B

500 parts of ethyl acetate are introduced into a reactor equipped with a thermocouple, a stirrer, a reflux condenser and a dropping funnel and heated to the reflux temperature. A mixture consisting of 178 parts of glycidyl methacrylate, 173 parts of methyl methacrylate, 70 parts of butyl methacrylate, 47 parts of styrene, 14 parts of n-dodecylmercaptan and 17 parts of 2,2-azobis(2-methylpropionitrile) is added over a period of 5 hours through the dropping funnel. When the addition is complete, the reaction mixture is boiled under reflux for one hour. Then, 10 parts of 2,2-azobis(2-methylpropionitrile) are added and the reaction mixture is kept under reflux for two additional hours. The solvent is distilled off under reduced pressure and the glycidyl group-containing acrylic copolymer is collected. The acrylic copolymer thus obtained is a solid product which is easily ground into a whitish powder. It has the following characteristics:
Epoxy Equivalent weight: 400 g/epoxy equivalent:
Brfld (Cone/Plate) 50000 mPa·s at 150° C.
Tg (DSC) 51° C.
Molecular weight distribution: Mn: 2120 and Mw 5845
Functionality: 5.3

As Example 3 a glycidyl containing acrylic resin prepared in a similar way and based on glycidyl methacrylate, methyl methacrylate, butyl methacrylate and styrene with commercial name of Almatex PD 3402 is used.
Epoxy Equivalent weight: 380 g/equivalent:
Brfld (Cone/Plate) 19000 mPa·s at 150° C.
Tg (DSC) 46° C.
Molecular weight distribution: Mn: 1732 and Mw 4612 and functionality of 4.6

The polyester and the glycidyl containing acrylic resin as illustrated above, were then formulated to a powder according to the formulation as mentioned below.

### Black Paint Formulation

| | |
|---|---|
| Binder | 100.0 |
| Carbon black | 2.0 |
| Modaflow P 6000 | 1.8 |
| Benzoin | 1.0 |

The binder composition of the different powder formulations is given in the table below.

The powders were prepared first by dry blending in a bag the different solid components and then by homogenization in the melt using a ZSK-30P extruder at an extrusion temperature of about 90° C. with a speed of 600 rpm. The homogenized mix was then cooled and grinded with Vortisiv. Subsequently the powder was sieved to obtain a particle size lower than 200 microns. The powder thus obtained was deposited on MDF or Q-Panel CRS 0.05 X 7,5 X 12.5 cm by electrostatic deposition using the GEMA—Optiflex-2 spray gun. At a film thickness of 50 to 140 microns the panels were cured in electrical heated oven, where curing was proceeded for 15 minutes at a object temperature of 180° C. unless differently reported. The composition of different polyester (components and amounts in weight) are reported in table 1 while in table 2 is reported in mole of glycols and acids %.

TABLE 1

| | EX. 1 | EX. 4 | EX. 5 | Comparative |
|---|---|---|---|---|
| NEOPENTYLGLYCOL | 424.5 | 374.1 | 414.9 | 406.1 |
| 1.6 HEXANEDIOL | 0.0 | 24.7 | 0.0 | 0.0 |
| TRIMETHYLOLPROPANE | 0.0 | 11.3 | 0.0 | 58.1 |
| CHDA | 0.0 | 72.9 | 0.0 | 0.0 |
| TRIMELLITIC | 0.0 | 15.7 | 0.0 | 76.2 |
| ANHYDRIDE | | | | |
| ISOPHTHALIC ACID | 721.4 | 627.9 | 728.2 | 593.1 |
| TRIBUTYLAMINE | 0.0 | 4.9 | 0.0 | 4.9 |
| BETP | 0.3 | 0.0 | 0.0 | 0.0 |
| YIELD | 1000 | 1000 | 1000 | 1000 |
| Number Average Molecular | 2363 | 2098 | 1603 | 2846 |
| weight | | | | |
| Weight Average Molecular | 6245 | 7645 | 4226 | 15128 |
| weight | | | | |
| Functionality (F) | 1.5 | 1.9 | 1.4 | 1.5 |
| Acid Number (AN) | 35 | 50 | 50 | 28.8 |
| Viscosity at 200° C. mPa · s | 2000 | 1800 | 1280 | 2420 |
| Glass Transition (Tg ° C.) | 61 | 52 | 59 | 59 |
| Hydroxyl Number (OHV) | 4.5 | 5.4 | 6.2 | 62.1 |

TABLE 2

| mole % | EX. 1 | EX. 4 | EX. 5 | Comparative |
|---|---|---|---|---|
| NEOPENTYLGLYCOL | 100 | 92.5 | 100 | 90.0 |
| 1.6 HEXANEDIOL | 0.0 | 5.4 | 0.0 | 0.0 |
| TRIMETHYLOLPROPANE | 0.0 | 2.2 | 0.0 | 10.0 |
| CHDA | 0.0 | 9.9 | 0.0 | 0.0 |
| TRIMELLITIC ANHYDRIDE | 0.0 | 1.9 | 0.0 | 10.0 |
| ISOPHTHALIC ACID | 100 | 88.2 | 100 | 90.0 |

The composition of the powder coatings are reported in table 3, curing of the single coating was done at 200° C.*10′ object temperature

TABLE 3

| | PC 1 | PC 2 | CPC 1 |
|---|---|---|---|
| EX. 1 | 86.0 | | 92.8 |
| EX. 4 | | 81.4 | |
| 2 methyl-imidazole | | | 0.2 |
| BETP | 0.75 | 0.74 | |
| TGIC | | | 7.0 |
| Primid XL 552 | 2.1 | 2.8 | |
| EX 3 | 11.2 | 15.1 | |
| MODAFLOW ® P 6000 | 1.8 | 1.8 | 1.8 |
| BENZOIN | 1.0 | 1.0 | 1.0 |
| carbon black | 2.0 | 2.0 | 2.0 |
| Total | 104.8 | 104.8 | 104.8 |
| Carboxy/(glycidyl + hydroxyalkylamide) | 50/50 | 50/50 | |
| equiv ratio | | | |
| Carboxy/triglycidyl equiv ratio | | | 46/54 |
| Glycidyl/Hydroxyalkylamide equiv ratio | 55/45 | 55/45 | |

2-methyl-imidazole is from Aalchem under the tradename of AHA 6312

TGIC is triglycidylisocyanurate from Niutang under the tradename of Nuitang TGIC-G

Benzoin is from Akros Organics

Carbon black is from Cabot under the tradename of Black Pearls 800

The paint characteristics for the finished coatings obtained from a binder according to the invention (PC1, PC2) and references (CPC 1) are given in table 4.

TABLE 4

| Row | | | PC 1 | PC 2 | CPC 1 |
|---|---|---|---|---|---|
| 1 | Gel Time (sec) | DIN 55990 | 30 | 44 | 47 |
| | | part 8 | | | |
| 2 | Inclined Plate Flow | PCI #7 | 29 | 36 | 46 |
| | (mm) | | | | |
| 3 | Smoothness @ | PCI #20 | 5-6 | 4 | 6 |
| | 100 μm | | | | |
| 4 | Gloss (units): 60°/20° | ASTM D523 | 95/76 | 97/83 | 91/62 |
| 5 | DOI | ASTM D523 | 35.5 | 45 | 25.1 |
| 6 | Impact Resistance | ASTM | 0/0 | 60/100 | 20/20 |
| | direct/indirect | D2794 | | | |
| 7 | Flexibility | ASTM D522 | 0.8 | 0.125 | 0.125 |
| 8 | Chemical resistance | PCI #8 | Pass (4) | Pass | Pass (4) |
| | | | | (4) | |
| 9 | Edge Coverage | ASTM | 2.5 | 2.5 | 0 |
| | (67.5V, 80 kΩ) | D5162 | | | |

Row 1: indicates gel time measured at 200° C.

Row 2: indicates the plate flow in mm measured at 180° C. from Powder Coating: The Complete Finisher's Handbook page 451, 4th ed. published by The Powder Coating Institute, 2012.

Row 3: indicates the visual evaluation on a 100 μm thickness, where 10 stands for very smooth high gloss coating and 1 stands for strong orange peel coating with a reduced 60° gloss value: from Powder Coating: The Complete Finisher's Handbook page 452-453, 4th ed. published by The Powder Coating Institute, 2012.

Row 4: indicates the gloss of the powder coatings at 60° and 20° according to ASTM D523.

Row 5: indicate the distinction of image (DOI) according to ASTM D523: where a higher value corresponds to good appearance of the coating.

Row 6: indicate the direct/indirect impact strength according to ASTM D2794. The highest impact which does not crack the coating is recorded in kg. cm.

Row 7: indicated the Erichsen cupping according to ASTM D522

Row 8: indicate the resistance to MEK measured on 100 μm, which corresponds to the appearance of the surface of the cured film (1=poor to 4=excellent) after 50 twofold rubbing movements (to and fro) with a cotton pad impregnated with detrimentally affecting MEK. from Powder Coating: The Complete Finisher's Handbook page 484-485, 4th ed. published by The Powder Coating Institute, 2012.

Row 9: indicates the edge coverage using the sponge test method measured according to ASTM D5162 as described above

The powders accordingly the invention (PC1 and PC2) produce single layer coatings with very good edge coverage in comparison with the reference based on the same resin of example 1 but combined with TGIC (Tris-glycidyl-isocyanurate) instead of the glycidyl containing acrylic resin B and β-hydroxyalkylamide D.

In order to understand the effect of different % of curing catalyst on the sponge test results, PC 1 and PC 2 have been prepared with an additional amount of BETP ranging from 0 to 1%, whereby PC3 is PC1 with 0.5% BETP and PC4 is PC1 with 1% BETP instead of 0.75%, and whereby PC5 is PC2 with 0.35% BETP and PC6 is PC2 with 0.5% BETP instead of 0.75% and CPC 3 is PC2 without BETP and the results after curing at 180° C. for 15 minutes object are reported in table 5 and 6.

TABLE 5

| | | CPC2 | PC3 | PC1 | PC4 |
|---|---|---|---|---|---|
| BETP addition % | | 0 | 0.5 | 0.75 | 1.0 |
| Gel Time at 200° C. | DIN 55990 | 54 | 37 | 29 | 27 |
| (sec) | part 8 | | | | |
| Inclined Plate Flow (mm) | PCI #7 | 41 | 33 | 29 | 27 |
| Smoothness @ 100 μm | PCI #20 | 6 | 6 | 6 | 4-5 |
| Gloss (units): 60°/20° | ASTM | 96/94 | 98/83 | 97/79 | 95/72 |
| | D523 | | | | |
| DOI | ASTM | 64.6 | 44.1 | 35.5 | 30.5 |
| | D523 | | | | |
| Flexibility | ASTM | 0.167 | 0.8 | 0.8 | 0.167 |
| | D522 | | | | |
| Edge Coverage | ASTM | 1.5 | 2 | 2.5 | 2 |
| (67.5V, 80 kΩ) | D5162 | | | | |

TABLE 6

| | | CPC 3 | PC5 | PC6 | PC2 |
|---|---|---|---|---|---|
| BETP addition % | | 0 | 0.35 | 0.5 | 0.75 |
| Gel Time at 200° C. | DIN | 55 | 48 | 46 | 44 |
| (sec) | 55990 | | | | |
| | part 8 | | | | |
| Inclined Plate Flow (mm) | PCI #7 | 50 | 45 | 43 | 36 |
| Smoothness @ 100 μm | PCI #20 | 6 | 5 | 5 | 4 |
| Gloss (units): 60°/20° | ASTM | 97/90 | 97/88 | 97/85 | 97/83 |
| | D523 | | | | |
| DOI | ASTM | 54.9 | 47.4 | 44.5 | 45 |
| | D523 | | | | |
| Impact Resistance | ASTM | 120/160 | 100/140 | 80/120 | 60/100 |
| | D2794 | | | | |
| Flexibility | ASTM | 0.167 | 0.167 | 0.167 | 0.125 |
| | D522 | | | | |
| Edge Coverage | ASTM | 1.0 | 2 | 2.5 | 2 |
| (67.5V, 80 kΩ) | D5162 | | | | |

Based on the results reported in table 5 and 6 it has been surprisingly found that the powder coatings need to contain at least 0.35% of BETP to meet the requested edge coverage rating, while CPC2 and CPC3, which have no BETP have a poor edge coverage.

TABLE 7

| | | PC2 | PC2 | PC2 |
|---|---|---|---|---|
| Curing | | 200° C.*10′ | 180° C.*10 | 180° C.*15′ |
| temperature | | | | |
| Gel Time at | DIN | 44 | 44 | 44 |
| 200° C. (sec) | 55990 | | | |
| | part 8 | | | |
| Inclined | PCI #7 | 36 | 36 | 36 |
| Plate | | | | |
| Flow (mm) | | | | |
| Smoothness @ | PCI #20 | 4 | 4 | 4 |
| 100 μm | | | | |
| Gloss (units): | ASTM D523 | 97/86 | 97/79 | 97/83 |
| 60°/20° | | | | |
| DOI | ASTM D523 | 47.1 | 36.6 | 45 |
| Impact | ASTM | 60/120 | 40/60 | 60/100 |
| Resistance | D2794 | | | |
| Flexibility | ASTM D522 | 0.125 | 0.125 | 0.125 |
| Chemical | PCI #8 | Pass (4) | Pass (4) | Pass (4) |
| resistance | | | | |
| Edge Coverage | ASTM | 2 | 2.5 | 2.5 |
| (67.5V, 80 kΩ) | D5162 | | | |

When tested at different times and temperatures PC2 demonstrates to provide very good edge coverage between 180° C. and 200° C. and cured for 10 and 15 minutes.

Additonal tests have been done verifying the effect of the % of pigments based on the powder coatings in black and in white reported in the table 8.

TABLE 8

| | PC2 | PC7 |
|---|---|---|
| EX. 4 | 81.37 | 81.37 |
| BETP | 0.74 | 0.74 |
| Primid XL 552 | 2.81 | 2.81 |
| EX 3 | 15.07 | 15.07 |
| MODAFLOW ® P 6000 | 1.80 | 1.80 |
| BENZOIN | 1.00 | 1.00 |
| carbon black | 2.00 | |
| Titanium dioxide KRONOS TR 2160 | | 35.16 |
| Total | 104.8 | 138.0 |

As reported in table 9 this has no effect on the outstanding edge coverage rating This result is combined with the same good flexibility smoothness and good chemical resistance.

TABLE 9

| | | PC2 | PC7 |
|---|---|---|---|
| Gel Time (sec) | DIN 55990 part 8 | 44 | 33 |
| Inclined Plate Flow (mm) | PCI #7 | 36 | 30 |
| Smoothness @ 100 μm | PCI #20 | 4 | 4 |
| Gloss (units): 60°/20° | ASTM D523 | 97/83 | 96/69 |
| DOI | ASTM D523 | 45 | 26.5 |
| Impact Resistance | ASTM D2794 | 60/100 | 20/60 |
| Flexibility | ASTM D522 | 0.125 | 0.125 |
| Chemical resistance | PCI #8 | Pass (4) | Pass (4) |
| Edge Coverage (67.5V, 80 kΩ) | ASTM D5162 | 2.5 | 2.5 |
| Corner coverage % | ASTM D2967-7 | 21 | |
| Edge Corrosion resistance mm | ASTM B117, | 0.5 | |
| | ASTM D1654 | | |

From the test results on PC2 we are also confirming that the edge coverage measured with ASTM D5162 represents a good prediction of the corner coverage measured according to ASTM D2967-7, where it's recognized that a good corner coverage is achieved when % of thickness on the corner of the bar is at least 15% of the thickness measured on the planar surface of the bar. Additionally, after the test of salt spray resistance of 500 hours based on ASTM B117 evaluated according to ASTM D1654 procedure C, the increase of the creep made on the edge of PC2 is only of 0.5 mm, when it's recognized that a good corrosion resistance is already achieved with less than 20 mm creep increase and, in the best case, of less than 5 mm.

Polyester of Ex. 5 from table 1 has been tested in white powder coatings in comparison with polyester of Ex. 4 and to the powder coating with Comparative polyester.

TABLE 10

| | | | PC |
|---|---|---|---|
| | PC7 | PC8 | Comparative |
| EX. 4 | 81.37 | | |
| EX.5 | | 81.37 | |
| Comparative | | | 90.20 |
| BETP | 0.74 | 0.75 | 0.42 |
| Primid XL 552 | 2.81 | 2.81 | 1.47 |
| EX. 3 | 15.07 | 15.07 | 7.92 |
| MODAFLOW ® P 6000 | 1.80 | 1.89 | 1.8 |
| BENZOIN | 1.00 | 1.00 | 1.0 |
| Titanium dioxide KRONOS TR 2160 | 35.16 | 35.16 | 35.2 |
| Total | 138.0 | 138.1 | 138 |

TABLE 11

| | | PC7 | PC8 | Comparative |
|---|---|---|---|---|
| Gel Time at | DIN 55990 | 33 | 32 | 30 |
| 200° C. (sec) | part 8 | | | |
| Inclined Plate | PCI #7 | 30 | 29 | 40 |
| Flow (mm) | | | | |
| Smoothness @ | PCI #20 | 4 | 5 | 4 |
| 100 μm | | | | |
| Gloss (units): | ASTM D523 | 96/69 | 92/58 | 91/52 |
| 60°/20° | | | | |
| DOI | ASTM D523 | 26.5 | 18.4 | 13.4 |
| Flexibility | ASTM D522 | 0.125 | 0.625 | 0.625 |
| Chemical | PCI #8 | Pass (4) | Pass (3) | Pass (3) |
| resistance | | | | |
| Edge Coverage | ASTM D5162 | 2.5 | 2.5 | 1 |
| (67.5V, 80 kΩ) | | | | |

From table 11 it is shown that even if with an increased Tg in comparison to Ex. 4, powder coating based on polyester of Ex. 5 is showing outstanding edge coverage.

Further, table 11 shows that the edge coverage of the comparative example where the OH value is more than 50 is much lower compared to the other coatings. In addition the distinction of image (DOI) is the lowest of all.

TABLE 12

| | PC7 | PC9 |
|---|---|---|
| EX 4 | 81.4 | 81.4 |
| BETP | 0.75 | 0.74 |
| Primid XL 552 | 2.8 | 2.8 |
| EX 3 | 15.1 | 0.0 |
| EX.2 | 0 | 15.1 |
| MODAFLOW ® P 6000 | 1.8 | 1.8 |
| BENZOIN | 1.0 | 1.0 |
| Titanium dioxide KRONOS TR 2160 | 35.2 | 35.2 |
| Total | 138 | 138 |

In table 12 and 13 is reported the comparison between 2 different glycidyl containing acrylic resins where powder coating based on the glycidyl containing acrylic resin of Ex. 2 is also able to provide good edge coverage.

TABLE 13

| | | PC7 | PC9 |
|---|---|---|---|
| Gel Time (sec) | DIN 55990 part | 33 | 27 |
| | 8 | | |
| Inclined Plate Flow (mm) | PCI #7 | 30 | 27 |
| Smoothness @ 100 μm | PCI #20 | 4 | 3 |
| Gloss (units): 60°/20° | ASTM D523 | 96/69 | 95/64 |
| DOI | ASTM D5239 | 26.5 | 20.7 |
| Flexibility | ASTM D522 | 0.125 | 0.625 |
| Chemical resistance | PCI #8 | Pass (4) | Pass (4) |
| Edge Coverage (67.5V, 80 kΩ) | ASTM D5162 | 2.5 | 2.5 |

1507 parts of GMA acrylic resin of example 3 are dry-blended in a bag with 74 parts of BETP and then homogenized in the melt at an extrusion temperature of about 90° C. with a speed of 600 rpm, then cooled and grinded (EX. 8)

TABLE 14

| | PC7 | PC10 |
|---|---|---|
| EX 4 | 81.37 | 81.37 |
| BETP | 0.74 | |
| Primid XL 552 | 2.81 | 2.81 |
| EX. 3 | 15.07 | |
| EX 8 | | 15.81 |
| MODAFLOW ® P 6000 | 1.80 | 1.80 |
| BENZOIN | 1.00 | 1.00 |
| Titanium dioxide KRONOS TR 2160 | 35.20 | 35.20 |
| Total | 138.0 | 138.0 |

TABLE 15

| | | PC7 | PC10 |
|---|---|---|---|
| Gel Time (sec) | DIN 55990 | 33 | 41 |
| | part 8 | | |
| Inclined Plate Flow (mm) | PCI #7 | 30 | 34 |
| Smoothness @ 100 μm | PCI #20 | 4 | 4 |
| Gloss (units): 60°/20° | ASTM D523 | 96/69 | 95/72 |
| DOI | ASTM D523 | 26.5 | 30 |
| Impact Resistance | ASTM D2794 | 20/60 | 40/60 |
| Flexibility | ASTM D522 | 0.125 | 0.125 |
| Edge Coverage (67.5V, 80 kΩ) | ASTM D5162 | 2.5 | 2.5 |

Table 15 shows that mixing catalyst C and acrylic resin B in an extruder to form a BC mixture is providing a composition with a better flow, and a coating with better impact resistance compared to mixing the polyester A, acrylic resin B and the catalyst C during the extrusion.

1. A powder coating composition comprising
an acid functional polyester resin A formed by reacting one or more polyol constituents, wherein at least 90 mole % of the polyols constituents is neopentylglycol, with one or more poly acid constituents wherein at least 87 mole % of the poly acid constituents is isophthalic acid (IPA); wherein polyester resin A has an Acid Number (AN) of between 20 and 90 mg KOH/g; and a hydroxyl value of less than 50, preferably less than 15 mg KOH/g;
a glycidyl functional acrylic resin B having a weight average molecular weight of between 2500 and 7000, wherein the weight average molecular weight was determined with Gel Permeation Chromatography (GPC) using polystyrene standards;
a curing catalyst C capable of catalyzing the reaction between the polyester resin A and the acrylic resin B; and
optionally β-hydroxyalkylamide D.

2. The powder coating composition according to claim 1,
a. wherein polyester resin A is present in an amount from 70 to 98.8 wt %;
b. wherein acrylic resin B is present in an amount from 1 to 30 wt %;
c. wherein the curing catalyst C is present in an amount from 0.2 to 1.3 wt %;
d. wherein β-hydroxyalkylamide D is present in an amount of from 0 and 5 wt %; wherein the amounts of wt % are in view of the total amount of weight of the powder coating composition.

3. The powder coating composition according to claim 1, wherein the ratio between the equivalents of acrylic resin B glycidyl groups (number of moles of glycidyl groups in resin B) combined with, if present, number of moles of hydroxylamide groups of β-hydroxyalkylamide D and the equivalents of carboxylic acid group of polyester resin A (number of moles of carboxylic groups in polyester resin A) is between 33/67 and 67/33, preferably between 45/55 to 55/45.

4. The powder coating composition according to claim 1, wherein the ratio between the equivalents of acrylic resin B glycidyl groups (number of moles of glycidyl groups in acrylic resin B) and, if present, number of moles of hydroxylamide groups of β-hydroxyalkylamide D is comprised between 100/1 and 40/60, preferably between 75/25 and 50/50.

5. The powder coating composition according to claim 1 containing
a. from 75 to 83 wt % of polyester resin A;
b. from 12 to 22 wt % of acrylic resin B;
c. from 0.3 to 1.2 wt % of curing catalyst C;
d. from 2 to 3.5 wt % of β-hydroxy-alkyl-amide;
wherein the amounts of wt % are in view of the total amount of weight of the powder coating composition.

6. The powder coating composition according to claim 1 wherein the polyester component A has one or more of the following characteristics:
a. the polyester resin A acid number of at least 20, preferably at least 30, more preferably at least 40 mg KOH/g, and the acid number of the polyester resin A is at most 90, preferably at most 75, more preferably at most 60 mg KOH/g;
b. the polyester resin A hydroxyl number is lower than 10 mg KOH/g;
c. the polyester resin A has a number average molecular weight (Mn) as determined by gel permeation chromatography (GPC) of at least 1000, preferably at least 1500;
d. the polyester resin A has a number average molecular weight (Mn) as determined by gel permeation chromatography (GPC) of at most 3000, preferably at most 2500;
e. the polyester resin A is an amorphous resin and preferably has a glass transition temperature measured by Differential Scanning Calorimetry (DSC) according to ASTM D3418 with a heating gradient of 10° C. per minute, comprised between 30 and 90° C., preferably at least 45° C.;
f. the polyester resin A has a functionality of at least 1.2 preferably at least 1.4 and more preferably at least 1.6, wherein the functionality is defined as the average number of acid groups per molecule as by “measured Mn”/(56100/ANV);
g. the polyester resin A has a functionality of at most 2.6 preferably at most 2.4 and more preferably at most 2.2 wherein the functionality is defined as the average number of acid groups per molecule as by “measured Mn”/(56100/ANV);
h. the glycol constituent of polyester resin A is composed from 90 to 100 mole per cent from neopentylglycol and from 0 to 10 mole per cent from other polyols;
i. the glycol constituents of polyester resin A are composed of from 90 to 100 mole per cent from neopentylglycol and from 0 to 10 mole percent of another glycol constituent selected from one or more aliphatic and/or cycloaliphatic glycols, such as: ethylene glycol, diethylene glycol, 1,3 propanediol, propylene glycol, 1,4-butanediol, 1,6-hexanediol, 1,4-cyclohexanediol, 1,4-cyclohexanedimethanol, 2-methyl-1,3-propanediol, 2-butyl-2-ethyl-1,3-propanediol, hydrogenated Bisphenol A, hydroxypivalate of neopentyl glycol. Preferably the other glycol constituents include 1,6-hexanediol;
j. the diacid constituents of polyester resin A are composed of from 87 to 100 mole percent of isophthalic acid, and of from 0 to 13 mole percent of another diacid constituent;
k. the diacid constituents of polyester resin A in general are composed of from 87 to 100 mole percent of isophthalic acid, and of from 0 to 13 mole percent of another diacid constituent selected from one or more aliphatic, cycloaliphatic and/or aromatic diacids, such as: terephthalic acid, fumaric acid, maleic acid, phthalic anhydride, 1,4-cyclohexanedicarboxylic acid, 1,3-cyclohexanedicarboxylic acid, 1,2-cyclohexanedicarboxylic acid, succinic acid, adipic acid, glutaric acid, pimelic acid, suberic acid, azealic acid, sebacic acid, 1,12-dodecanedioic acid, undodecanedioic acid, tridecanedioic acid, tetradecanedioic acid, hexadecanedioic acid, eptadecanedioic acid, octadecanedioic acid, or the corresponding anhydrides and any mixture thereof. 1,4-cyclohexanedicarboxylic acid (CHDA) and adipic acid are the most preferred;
l. the sum of polyols with at least 3 OH groups and polybasic organic carboxylic acid constituent of polyester A in general are present as from 0 to 10 mole percent of the total of polyols and carboxylic acids of polyester resin A and are preferably trimethylolpropane and trimellitic anhydride;
m. the carboxylic acid functional polyester component A according to the present invention are preferably prepared reacting all the polyols with all the di- and poly-carboxylic acids and/or their anhydrides in a single step.

7. Powder coating composition according to claim 1, wherein the curing catalyst C is selected from the goup consisting of ethyl-triphenyl-phosphonium bromide, tributylamine, or 2-methyl-imidazole or a mixture thereof.

8. The composition according to claim 1, wherein the glycidyl functional acrylic resin B has at least one of the following characteristics:
a. an epoxy equivalent weight of at least 280, preferably at least 320, more preferably at least 360 g/eq; and at most 500, preferably at most 450, more preferably at most 400 g/eq;
b. a number average molecular weight (Mn) as determined by gel permeation chromatography (GPC) of at least 1000, preferably at least 1200;
c. a glass transition temperature, measured by Differential Scanning Calorimetry (DSC) according to ASTM D3418 with a heating gradient of 10° C. per minute, of from 35 to 60° C.;
d. a Brookfield cone and plate viscosity according to ASTM D4287-88, measured at 150° C., ranging from 10.000 to 75.000 mPa·s and preferably between 15.000 and 55.000 mPa·s;
e. a functionality higher than 2.5 and lower than 8.5 (functionality defined as the average number of glycidyl groups per molecule as by “measured Mn”/EEW).

9. The powder coating composition according to claim 1 wherein the glycidyl functional acrylic resin B has following characteristics:
a. an epoxy equivalent weight of at least 280, preferably at least 320, more preferably at least 360 g/eq and at most 500, preferably at most 450, more preferably at most 400 g/eq;
b. a number average molecular weight (Mn) as determined by gel permeation chromatography (GPC) of at least 1000, preferably at least 1500; and number average molecular weight of at most 2500, preferably at most 2000;
c. a glass transition temperature, measured by Differential Scanning Calorimetry (DSC) according to ASTM D3418 with a heating gradient of 10° C. per minute, of from 35 to 50° C.;
d. a Brookfield cone and plate viscosity according to ASTM D4287-88, measured at 150° C., ranging from 10.000 to 40.000 mPa·s and preferably between 15.000 and 25.000 mPa·s.

10. The powder coating composition according to claim 1, wherein the content of polyester resin A, acrylate resin B, catalyst C and if present the β-hydroxyalkylamide D is from 60 to 100 wt % in view of the total powder coating composition.

11. The powder coating composition according to claim 1, wherein the gel time of the composition measured at 200° C. is below 100 seconds, preferably between 20 and 50 seconds.

12. The powder coating composition according to claim 1, wherein the composition provides an edge coverage rating of at least 2.0 when tested using Low Voltage Wet Sponge Test Method (ASTM D5162); and/or wherein the composition provides a corner coverage of more than 10%, preferably more than 15%, even more preferably more than 20% according to the Standard Test Method for Corner Coverage of Powder Coatings (ASTM Method D2967-7),

13. A process for providing a good edge coverage of a metal substrate comprising the steps of:
contacting an uncoated metal substrate having a surface and an edge with a single layer of a powder coating composition according to claim 1;
curing the powder coating composition;
wherein the powder coating composition provides an edge coverage rating of at least 2.0 when tested using Low Voltage Wet Sponge Test Method (ASTM D5162).

14. The process according to claim 13, wherein the curing occurs at a temperature ranging from 160 to 210° C. preferably from 180° C. to 200° C., during 10 to 30 minutes preferably 10 to 15 minutes.

15. The process according to claim 13, wherein the single layer after curing has a thickness of from 50 to 125 μm.

16. Method for making a powder coating composition according to claim 1, comprising the steps of
preparing acrylic resin B in a reactor;
mixing acrylic resin B with catalyst C before or while leaving the reactor to form a BC mixture; or
mixing acrylic resin B with catalyst C through extrusion to form a BC mixture; or
mixing acrylic resin B with catalyst C through dry-blending to form a BC mixture;
dry blending the BC mixture, the polyester resin A and optionally β-hydroxyalkylamide D to form a blend;
extruding the blend to form a homogenized mixture;
cooling and grinding the homogenized mixture.

17. An article, preferably having a metal substrate, coated, either partly or entirely, with the a powder coating composition according to claim 1.

18. A metal substrate made by a process according to claim 13.

19. Use of the powder coating composition according to claim 1, or made by the method according to claim 16, for providing a good edge coverage of a metal substrate by applying a single layer, whereby the powder coating composition provides an edge coverage of at least 2.0 when tested via the Low Voltage Wet Sponge test method (ASTM D5162).
